(19) United States
(12) Patent Application Publication
(10) Pub. No.: US 2010/0021094 A1
(43) Pub. Date: Jan. 28, 2010

(54) HIGH-TEMPERATURE BEARING ASSEMBLIES AND METHODS OF MAKING THE SAME

(76) Inventors: Christopher Alan Kaufman, Fort Wayne, IN (US); David Frederick Grabner, Roanoke, IN (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 12/510,113

(22) Filed: Jul. 27, 2009

Related U.S. Application Data
(60) Provisional application No. 61/083,834, filed on Jul. 25, 2008.

(51) Int. Cl. F16C 23/08; B21D 53/10

(52) U.S. Cl. 384/209; 29/898.043

(57) ABSTRACT

High-temperature bearing assemblies and methods of making the same are provided. A high-temperature bearing assembly generally includes a swivel device disposed in a socket, and a race disposed between the socket and the swivel device, wherein the race is made from a high-temperature plastic.

### CROSS-REFERENCE TO RELATED APPLICATION

This application claims the benefit of U.S. Provisional Application No. 61/083834, filed on Jul. 25, 2008, the disclosure of which is hereby expressly incorporated by reference.

### BACKGROUND

Previously designed rod end bearings for vehicle engines mainly incorporated straight pin and clevis (non-misaligning) pivot joints. These pivot joints have multiple drawbacks, including binding, excessive wearing, and corrosion pitting. With many present-day engines requiring tighter tolerances and better responses at high-temperatures, new pivot joint designs are needed.

There have been several unsuccessful attempts at solving the problems described above. For example, rod end bearings with undesirable misalignment (or more free movement in the bearing) have been designed to attempt to avoid binding. Moreover, multiple variants of high-temperature coatings and/or lubricants have been developed to help increase the corrosion and wear resistance. These coatings or lubricants, while increasing lubricity and protecting from corrosion, did not exhibit the life or wear resistance needed to survive the harsh engine environments, extreme vibration, or high exhaust temperature conditions. In addition, attempts were made using high-temperature specialty alloy steels, but the same issues present with the coatings also surfaced with specialty alloy steels: little or no resistance to vibrational wear at high-temperatures. Previous uses of higher temperature plastics have also been unsuccessful, because the materials were either too brittle or not capable of being formed into the shape needed for this high-temperature bearing race.

Therefore, there exists a need for a new high-temperature rod end bearing having resistance to high-temperature, vibration, life cycle, and corrosion.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, a high-temperature bearing assembly is provided. The bearing assembly generally includes a housing portion defining a socket, a swivel device disposed in the socket, and a race disposed between the socket and the swivel device, wherein the race is made from a high-temperature plastic.

In accordance with another embodiment of the present disclosure, a high-temperature bearing assembly is provided. The bearing assembly generally includes a housing portion defining a socket, a swivel device disposed in the socket, and a race disposed between the socket and the swivel device. The race is formed from a high-temperature plastic and the race includes a gap, such that the race collapses when the swivel device is crimped in the socket.

In accordance with another embodiment of the present disclosure, a high-temperature bearing assembly is provided. The bearing assembly generally includes a swivel device disposed in a socket, and a race disposed between the socket and the swivel device, wherein the race is made from a high-temperature plastic.

In accordance with another embodiment of the present disclosure, a method of making a high-temperature bearing assembly is provided. The method generally includes forming a race from a high-temperature plastic, wherein the race is formed in a substantially C-shape, and compressing the race around a swivel device to create a swivel assembly. The method further includes inserting the swivel assembly in a socket, such that the race is positioned between the socket and the swivel device, and crimping the swivel assembly in the socket.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a perspective view of a high-temperature bearing assembly formed in accordance with one embodiment of the present disclosure;

FIG. 2 is an exploded view of the high-temperature bearing assembly of FIG. 1;

FIG. 3 is a front view of the high-temperature bearing assembly of FIG. 1;

FIG. 4A is a cross-sectional side view of the high-temperature bearing assembly of FIG. 1 through the plane 4-4 in FIG. 3 in an uncrimped configuration;

FIG. 4B is a cross-sectional side view of the high-temperature bearing assembly of FIG. 1 through the plane 4-4 in FIG. 3 in a crimped configuration; and

FIG. 5 is a cross-sectional side view of a high-temperature bearing assembly formed in accordance with another embodiment of the present disclosure.

### DETAILED DESCRIPTION

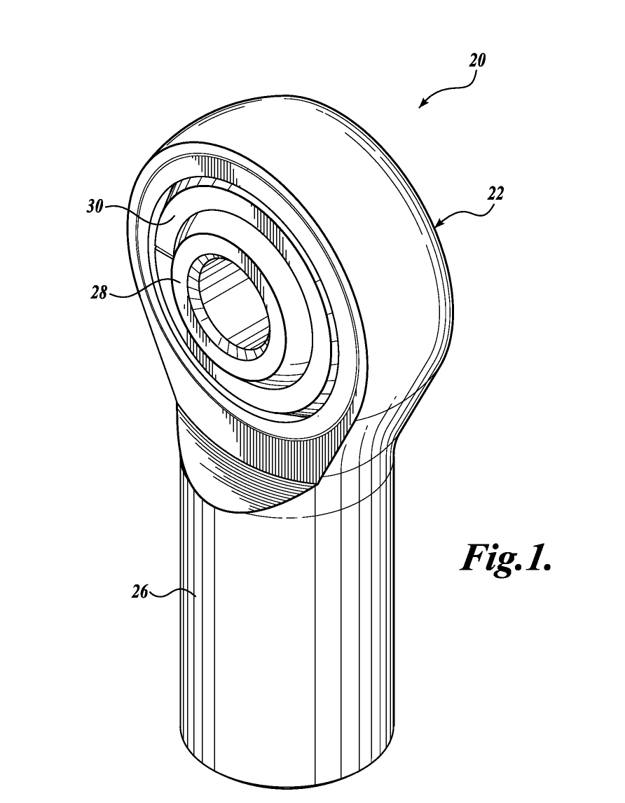

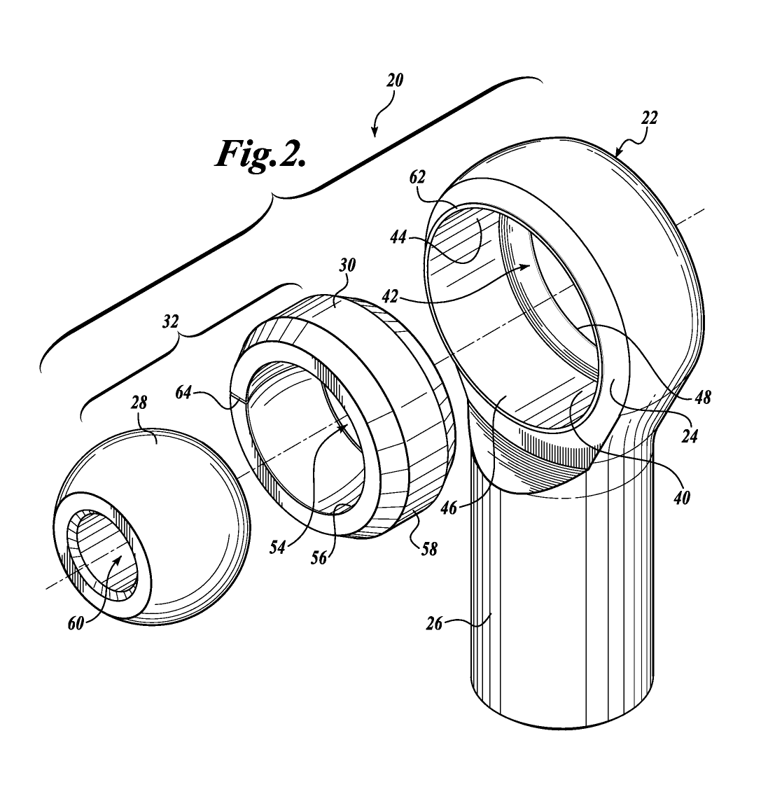

A high-temperature bearing assembly constructed in accordance with one embodiment of the present disclosure may be best understood by referring to FIGS. 1-4B. The bearing assembly 20 includes a housing portion 22 having a head 24 and a shaft 26 extending from the head 24. The bearing assembly 20 further includes a swivel device 28 and a race 30 in surrounding relationship with the swivel device 28, wherein the swivel device 28 and a race 30 define a bearing 32. The bearing 32 is disposed in the head 24. In use, the bearing 32 is configured to swivel in the head 24 and allow for pivoting movement of the bearing 32 relative to the head 24. As described in greater detail below, the race 30 is designed to improve the life and wear resistance of the bearing assembly 20 in harsh engine environments, extreme vibration, and/or high-temperature conditions.

The improved characteristics of a bearing assembly 20 in accordance with embodiments of the present disclosure improve the capabilities of the bearing assembly 20, such as high-temperature and vibration tolerance and life cycle wear. Such high-quality bearings can be used to position highly sensitive electronic controlled sensors and hydraulic or pneumatic actuation systems. In that regard, this positioning is achieved with minimal lost motion, otherwise described as decreased sensitivity or accuracy in the control systems. In the past, many controls were merely required to open or close valves or louvers; however, now with greater focus on emission standards and operating efficiency, exact bearing positioning is required. As described in greater detail below, the bearing assembly 20 described herein helps achieve exact positioning by allowing the controls to place the output where it is expected to register and thus meeting the efficiency needs of various engine control systems throughout the lives of the systems.

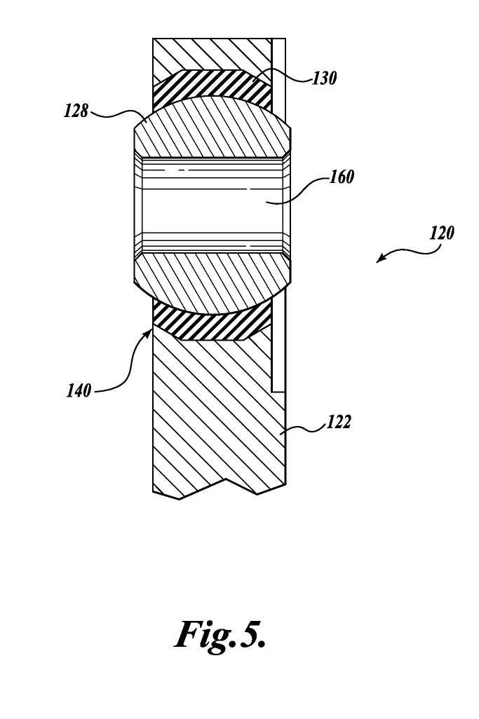

In the illustrated embodiment of FIGS. 1-4B, the bearing assembly 20 is a rod end bearing assembly, with the housing portion 22 being a rod end. Although illustrated as a rod end bearing assembly 20, it should be appreciated that other types of bearings, including but not limited to spherical bearings, plate bearings (see, e.g., FIG. 5), and other mechanical articulating joints, are also included in the scope of the present disclosure. In that regard, other suitable housings include but are not limited to flat stock and plates, flattened and pierced rods, hoops, etc. Such joints are used on the ends of control rods, steering links, tie rods, or anywhere a precision articulating joint is required.

In the illustrated embodiment, the bearing 32 can be pressed and crimped into the head 24 in a manner that allows for pivoting movement of the bearing 32 in the head 24. As a result of the swivel motion, the bearing assembly 20 provides a pivot joint between two parts (not shown). In that regard, the first part would be connected to the swivel device 28 and the second part would be connected to the end shank of the housing portion 22.

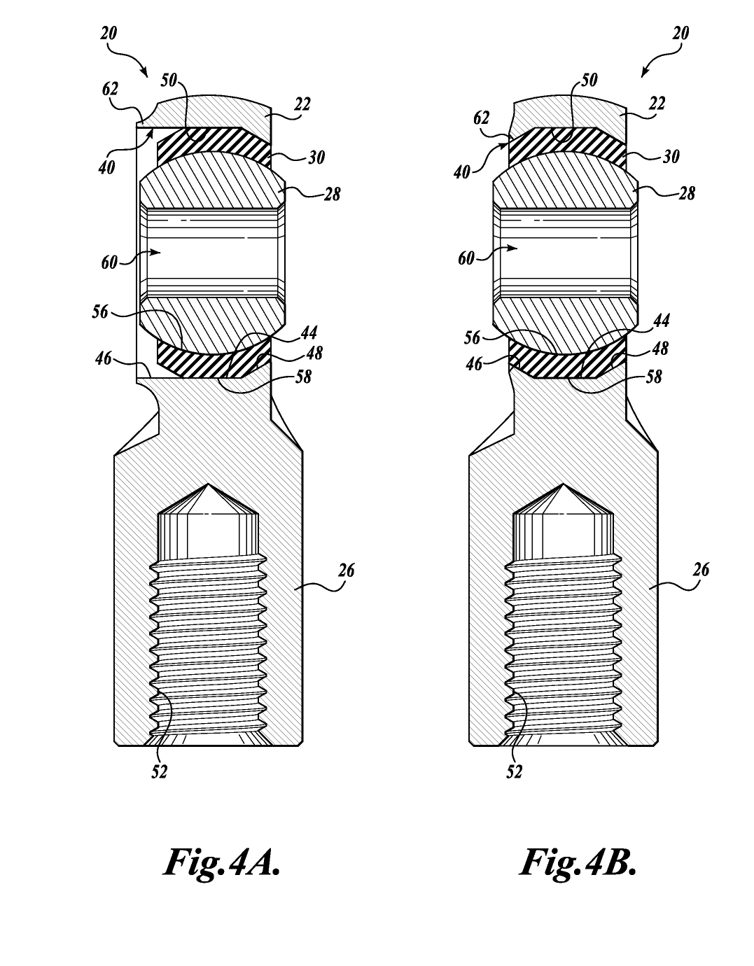

As mentioned above, the housing portion 22 includes a head 24 and a shaft 26 extending from the head 24. The head 24 includes a socket 40 for receiving the bearing 32. In that regard, the socket 40 has an inner bore 42 that extends through the socket 40, wherein the inner bore 42 has an inner wall 44 and first and second ends 46 and 48. The socket 40 is configured to hold the bearing 32, but allows for pivotal movement of the bearing 32 relative to the head 24. As described in greater detail below with reference to FIGS. 4A and 4B, the first end 46 of the socket 40 includes a crown 62, which begins in an extended position (see FIG. 4A) and is crimped into a retracted position (see FIG. 4B). When crimped into the retracted position, the crown 62 holds the swivel device 28 and race 30 in the socket 40.

As best seen in FIG. 4B, the inner wall 44 of the socket 40 is configured as a raceway for receiving and holding the swivel device 28 and race 30 with appropriate resistance for the application of the bearing assembly 20. In the illustrated embodiment, the inner wall 44 is designed as having a circular cross-sectional diameter, with varying circular diameter along a center axis that extends through the inner bore 42. In that regard, the inner wall 44 has a concave annular recess and is configured to have a smaller diameter at the first and second ends 46 and 48 than in the middle of the raceway when in the crimped position. As such, the inner wall 44 defines a depression 50 along the inner perimeter to receive and hold a spherical or partially spherical swivel device 28 and race 30.

The shaft 26 of the housing portion 22 extends from the head 24 and may be a threaded shaft of either the female type having a receiving portion 52 (see FIGS. 4A and 4B) or the male type (not shown). The shaft 26 is connectable to the second part (not shown), for example, by receiving a threaded fastener (not shown) within the receiving portion 52 of the shaft 26. In an exemplary vehicle engine application, the second part may be another bearing that may be connected to a lever to actuate a turbo vane location.

As mentioned above, the swivel device 28 may be a spherical ball swivel or a partially spherical ball swivel. In that regard, the swivel device 28 is configured to swivel with appropriate resistance within the socket 40. The swivel device 28 may include an opening 60 through which a bolt or other attaching hardware (not shown) may pass to connect the swivel device 28 to the first part (not shown). In an exemplary vehicle engine application, the first part may be an electronically controlled actuator.

Still referring to FIG. 4B, the race 30 is disposed between the socket 40 and the swivel device 28. The race 30 provides a cushion between the socket 40 and the swivel device 28 for lubrication and to prevent wear of the socket 40 and the swivel device 28. The race 30 is suitably formed to interface with the inner wall 44 of the socket 40 so as to provide suitable resistance between the race 30 and the socket 40 when the swivel device 28 is moved. In that regard, the race 30 has a center cavity 54 and inner and outer walls 56 and 58. Like the raceway, the race 30 has a circular cross-sectional diameter with varying circular diameter along a center axis that extends through the center cavity. The inner wall 44 includes a concave annular recess to receive and hold a spherical or partially spherical swivel device 28. The outer wall 58 protrudes to interface with the depression 50 in the inner wall 44 of the socket 40.

In accordance with embodiments of the present disclosure, the race 30 is designed to be reliable in harsh engine environments, extreme vibration, and/or high exhaust temperature conditions. In one embodiment, the race 30 is made from a high-temperature plastic. In another embodiment, the race 30 may have high-temperature resistance up to at least about 450 degrees F. In another embodiment, the race 30 may have high-temperature resistance up to at least about 550 degrees F. In another embodiment, the race 30 may have high-temperature resistance up to at least about 650 degrees F. In another embodiment, the race 30 may have high-temperature resistance up to at least about 750 degrees F. In another embodiment, the race does not vary more than 5% from its original shape and size over time, for example, under a low load of about 10 lbs during life cycle testing.

The race 30 is suitably made from a high-temperature plastic having some ductility that can be formed, for example, by injection molding or direct compression molding into a suitable design. One suitable high-temperature plastic is a thermoplastic polymer. A non-limiting example of a suitable high-temperature, high-performance plastic is VICTREX®PEEK™ polyether-ether-ketone thermoplastic (PEEK). The plastic can be molded, for example, by injection molding, into the desired shape of the race, and then can be subsequently inserted into the socket 40 together with the swivel device 28 and crimped into place (see FIG. 4B). PEEK provides high-temperature resistance up to at least about 450 F. Another suitable race material may be polyether-ketone-ether-ketone-ketone (PEKEKK). PEKEKK provides high-temperature resistance up to at least about 550 F.

Another suitable race material is a polyimide plastic. A non-limiting example of a suitable high-temperature polyimide plastic is DUPONT™ VESPEK® polyimide-based polymer. Other grades and brands of polyimide plastics are also within the scope of the present disclosure. Polyimides have high-temperature resistance up to about 650 degrees F. with excursions up to about the mid-700 degree F. range. However, such polyimide materials must be formed by direct compression molding under high pressure, rather than being injection molded, and may require secondary machining after being formed.

In accordance with embodiments of the present disclosure, the race 30 is required to retain its strength in both the axial and radial directions at temperatures of up to and including about 700 F. In a preferable embodiment, the heat deflection temperature of the race is at least approximately the same as the designed maximum operating temperature of the system in which the bearing assembly 20 will perform, for example, at least about 450 F, at least about 550 F, at least about 650 F, at least about 750 F, etc., depending on the application requirements. In addition to strength, the race is required to resist vibration and life cycle wear. In a preferable embodiment, the race has less than a 5% change from its initial free motion limits.

As described in greater detail below in EXAMPLES 1 and 2, the inventors have found that high-temperature and life cycle performance of ceramic, metal-on-metal including high-temperature coatings, and plastics having low glass transition or heat deflection temperatures did not perform as well as the plastic materials described herein. In general, the inventors have found that low glass transition or heat deflection temperature plastics deform at high-temperatures, ceramics crack under high loads, and metal-on-metal wears under life cycle testing to affect the key characteristics of the bearing assembly (torque and free motion). Moreover, metal-on-metal bearings have a tendency to corrode and bind in extreme conditions.

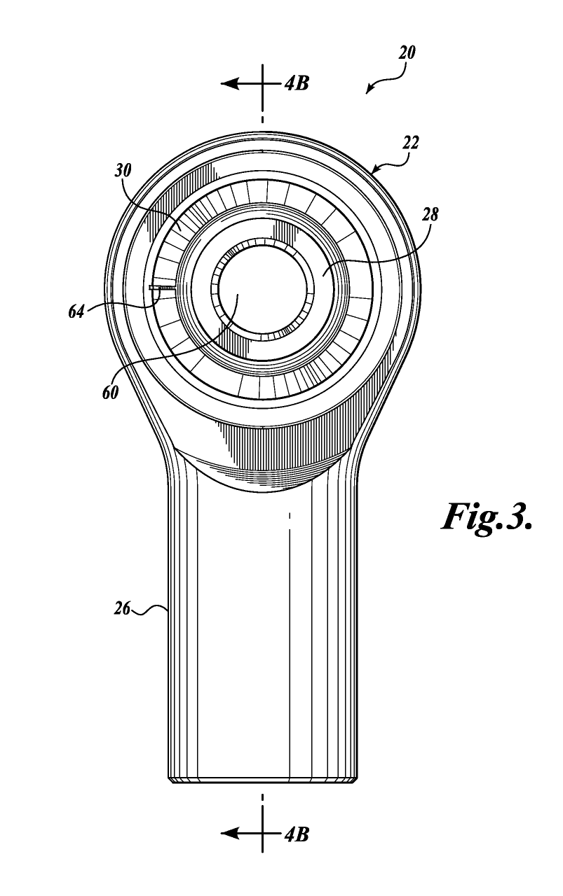

As best seen in the illustrated embodiment, the race 30 may be formed with a gap 64, for example, in a C-shaped design to help accommodate for differences in ductility in the race material, as well as in the various assembly methods (see FIG. 3). In the C-shaped design, the race 30, while substantially circular in cross-sectional shape, has a gap 64 along its circular arc. When the race 30 is compressed to fit in the head 24 between the swivel device 28 and the socket 40, the gap 64 allows the race 30 to collapse without damaging the race 30, the socket 40, or the swivel device 28. The collapsability of the C-shaped race design gives ideal grip and ball-to-race conformity. This conformity increases the wear surface of the race 30, thus allowing for greater vibrational absorption and load distribution within the bearing assembly 20 by the race 30. Although shown in the illustrated embodiment in a C-shaped design, it should be appreciated that fully circular races are also within the scope of the present disclosure.

The size of the gap 64 in the C-shaped design depends on several factors, including but not limited to the specific application for the bearing assembly 20, expected expansion or swelling in the materials of the head 24, swivel device 28, or the race 30, etc. In one non-limiting example, the gap 64 may be sized to be up to about 0.020 inches. It should be appreciated that, while shown as a C-shaped design, the race 30 may also be designed to have more than one gap, for example, the race may be comprised of two or more parts that together define a race having a substantially circular cross-section. The advantage of the C-shaped design is that it allows for a gap 64 without requiring multiple parts. The collapsability and conformity characteristics of the C-shaped race 30 were shown to be consistent even at high-temperatures when plastics usually become susceptible to deformation at load.

Methods of making the bearing assembly 20 described above will now be described in greater detail. As mentioned above, the race 30 may be formed, for example, by injection molding or direct compression molding, into a suitable shape. If formed by the compression molding, the race will likely require secondary machining during formation to meet the desired specifications.

Referring to FIG. 4A, the race 30 is then inserted into the socket 40 together with the swivel device 28. In that regard, the race 30 is compressed around the swivel device 28 and then the bearing 32 (or combination race 30 and swivel device 28) is nested in the socket 40. In accordance with another method of the present disclosure, the race 30 may be inserted into the socket 40 independent of the swivel device 28, either before or after the swivel device 28 is inserted in the socket 40.

When the race 30 and swivel device 28 are inserted in the socket 40, the torque of the bearing assembly 20 is tested using a test press that moves the swivel device 28 relative to the socket 40 to achieve the desired torque without limited free movement in the socket 40. When the desired torque is achieved, the crown 62 is crimped in place to maintain the swivel device 28 and race 30 in the socket 40 at the desired torque (see FIG. 4B). In accordance with one method of the present disclosure, after the crown 62 has been crimped in place, the test press releases its load, but the swivel device 28 continues to be moved by the test press to ensure that the proper crimping and proper torque have been achieved.

As discussed above, increased sensitivity and accuracy in control systems have become important in bearing applications. It should be appreciated that the exactness of the torque measurements achieved by the methods of making the bearing assembly described herein allow for accurate control systems and prevent undesirable misalignment (or free movement) in the bearing assembly 20.

In some high-temperature applications, the inventors have found that the race material may have some expansion during use. This expansion affects the desired resistance between the swivel device 28 and the socket 40 during use. In order to address this problem, the race 30 is configured in the C-shaped design, with a gap 64 to allow for swelling or expansion into the gap 64. In addition, the race 30 may also be pre-baked before use in the bearing assembly 20 to a high-temperature of about 700 degree F. Such a pre-bake anneals the race 30 and prevents additional expansion during use. However, it should be appreciated that the pre-bake annealing is not required in all application because of variations in temperature and loading during application, which also affects the capabilities and requirements of the bearing assembly.

Now turning to FIG. 5, a bearing assembly formed in accordance with another embodiment of the present disclosure will be described in greater detail. The bearing assembly is substantially identical in materials and operation as the previously described embodiment, except for differences regarding the housing portion of the bearing assembly, which will be described in greater detail below. For clarity in the ensuing descriptions, numeral references of like elements of the bearing assembly 20 are similar, but are in the 100 series for the illustrated embodiment of FIG. 5.

As mentioned above, embodiments of the present disclosure are not limited to rod end bearing assemblies. In the illustrated embodiment, a plate bearing assembly 120 is shown. Referring to FIG. 5, the plate bearing assembly 120 includes a housing portion 122, wherein the housing portion 122 is substantially a plate defining one or more sockets 140. Like the sockets described above in the illustrated embodiment of FIGS. 1-4A, the sockets 140 of this embodiment are configured to receive swivel devices 128 having races 130 disposed between the swivel devices 128 and the internal surfaces of the sockets 140. Although one socket 140 and one swivel device 128 is shown in the illustrated embodiment, it should be appreciated that the housing portion 122 may be configured to receive any number of swivel devices 128.

### EXAMPLE 1

### Strength Data at High-Temperatures

Strength testing in a rod end bearing assembly was performed in two directions at temperatures of up to and including 700 F: axial direction (direction of axis of bore) and radial direction (direction of axis of housing). Several different materials were used for the race in the strength testing, including a ceramic, a nylon plastic, a polyimide, and a PEEK race, as well as a metal-on-metal bearing having a high-temperature coating, such as an electroless nickel TEFLON® coating. The results of the testing are listed below in TABLE 1. The “PASS” or “FAIL” indicators are directed to whether bearing retention loads of about 250 lbs could be sustained through a temperatures cycle from about 68 F (room temperature) up to about 700 F (high-temperature).

TABLE 1
STRENGTH DATA AT HIGH-TEMPERATURES

| Race Material | 68 F. | 700 F. |
|---|---|---|
| Ceramic | FAIL | FAIL |
| Nylon | PASS | FAIL |
| DUPONT ™ VESPEL ®polyimide- | PASS | PASS |
| based polymer | | |
| VICTREX ®PEEK ™ polyether- | PASS | PASS |
| ether-ketone thermoplastic | | |
| Steel having electroless nickel | PASS | PASS |
| TEFLON ®coating | | |

The metal-on-metal bearing with a high-temperature coating performed the best in the strength testing test as a result of the all-steel construction. However, metal-on-metal bearings tended to fail in life cycle testing, described below in EXAMPLE 2.

The plastics (nylon, polyimide, and PEEK) and ceramic races had very high ultimate compression strengths, which resulted in the bearing assembly successfully withstanding high loads in the radial direction. Failure mode testing often resulted in a housing or connecting linkage failing before the race and swivel failed under load in the radial direction.

In the axial direction, the differences in strength between the plastic and ceramic races became more prevalent. Due to the low-fracture toughness of ceramics, the ceramics failed almost immediately regardless of temperature. In most tests, the ceramics cracked at loads of 70% less than the other materials (plastics and metal-on-metal).

The ultimate failure mode in unacceptable plastic races (such as nylon) was seen at or near the heat deflection temperatures of the various plastics. Bearing retention loads would be reduced to nearly zero when the material approached the heat deflection temperature due to loss of the race stiffness. Many common polymers, such as nylons, have heat deflection temperatures well below the high-temperature applications of up to and including about 700 F.

In high-grade polyimide and PEEK materials, the heat deflection temperature is considerably higher than required for expected high-temperature applications. Rather than melting, polyimide plastics tend to oxidize over time at high-temperatures (such as over 800 F) and will degrade the binders in the material such that the plastic becomes brittle. Oxidization was not observed in the testing. In that regard, the polyimide race retained over 95% of its original strength from testing that occurred from about -40 F to up to about mid-500 F or to about mid-700 F based on the specific grade of polyimide and the specific loading and application of the bearing. Because the polyimide material does not melt in the temperature range, like the unacceptable plastic races, some oxidation degradation can be acceptable, particularly at low-loading conditions.

### EXAMPLE 2

### Life Cycle Data

Life cycle testing included variants in amount of repetitive (e.g., up to 30 million cycles) cyclic travel (angular movement of the linkage, e.g., 20 degrees sweeps back and forth) through the expected temperature range of the application (e.g., up to and including 700 F). Several different materials were used for the race in the life cycle, including a polyimide race, a PEEK race, and metal-on-metal bearings having various high-temperature coatings, such as electroless-nickel TEFLON® and high-temperature dry film lubricant (moly). Notably, ceramic and nylon races were not tested due to their failure in the strength testing described above in EXAMPLE 1.

The results of the testing are listed below in TABLE 2. The data shows an increase in play or free movement in percentages in bearing assemblies having races made from the various materials after 20,000,000 cycles as temperature cycles from about 70 F (approximately room temperature) to application specific temperature highs, such a about 700 F under a negligible bearing load of less than about 10 lbs.

TABLE 2
AXIAL PLAY AFTER 20,000,000 CYCLES

| | Average % Gain in Free Play |
|---|---|
| Race Material | at Completion of Cycles |
| DUPONT ™ VESPEL ®polyimide- | less than 5% |
| based polymer | |
| VICTREX ®PEEK ™ polyether- | less than 5% |
| ether-ketone thermoplastic | |
| Steel having electroless nickel | more than 100% |
| TEFLON ®coating | |
| Steel having high-temperature dry | more than 100% |
| film lubricant (moly) | |

After life cycle testing, the metal-on-metal bearing with a high-temperature coating consistently wore in key points in the cyclic travel, resulting in undesired changes in torque and undesired changes in the free motion of the bearing assembly. The inventors found that the coatings degraded during cyclic travel as a result of the repetitive movement of two unforgiving metal surfaces making contact with each other at load; therefore, the slope of degradation was drastic. In most tests, the inventors found that the key characteristics (torque and free motion) would change at about 50% of the expected life cycle. Initially, the parts would tighten from an increase in debris in the socket (i.e., shavings or worn particles from the bearing or raceway itself). The torque required to actuate the linkage would increase at this point. As the parts degraded, the wear would accelerate to a point where the free motion was beyond acceptable levels for accurate movement within the system. Data showed that once the coatings were worn (usually within half of the expected life cycle), subsequent wear would increase by 10 fold compared to the initial free movement in the system. At that level of free movement, the swivel itself would likely become dislodged from the raceway. This type of wear was even more profound when subjected to accelerated wear testing that included debris (dust, sand) and/or vibrational testing with temperature cycles.

The plastic materials (e.g., polyimide and PEEK) in these applications do not have the same frictional wear as metal-on-metal due to the self-lubricating characteristics of plastics. In addition, the plastics absorbed the impact stresses during vibrational testing. However, the life cycle test in conjunction with heat cycles (e.g., up to and including 700 F) accelerated the breakdown of the unsuccessful plastics (e.g., nylon). Acceptable polyimide and PEEK materials did not vary more than 5% from their initial free-motion limits.

While illustrative embodiments have been illustrated and described, it will be appreciated that various changes can be made therein without departing from the spirit and scope of the invention.

The embodiments of the invention in which an exclusive property or privilege is claimed are defined as follows:

1. A high-temperature bearing assembly, comprising:
(a) a housing portion defining a socket;
(b) a swivel device disposed in the socket; and
(c) a race disposed between the socket and the swivel device, wherein the race is made from a high-temperature plastic.

2. The bearing assembly of claim 1, wherein the race has a high-temperature resistance selected from the group consisting of up to at least about 450 degrees F., up to at least about 550 degrees F., up to at least about 650 degrees F., and up to at least about 750 degrees F.

3. The bearing assembly of claim 1, wherein the material of the race includes a material selected from the group consisting of a polyimide-based polymer, a polyether-ether-ketone thermoplastic, and a polyether-ketone-ether-ketone-ketone thermoplastic.

4. The bearing assembly of claim 1, wherein the race is formed by compression molding or injection molding.

5. The bearing assembly of claim 1, wherein the race is substantially C-shaped.

6. The bearing assembly of claim 1, wherein the race includes a gap.

7. The bearing assembly of claim 6, wherein the gap is less than or equal to about 0.020 inches.

8. The bearing assembly of claim 1, wherein the race does not change more than 5% in shape or size.

9. The bearing assembly of claim 1, wherein the race and the swivel device are crimped in the socket.

10. The bearing assembly of claim 1, wherein the housing portion is selected from the group consisting of a rod end and a plate.

11. A high-temperature bearing assembly, including:
(a) a housing portion defining a socket;
(b) a swivel device disposed in the socket; and
(c) a race disposed between the socket and the swivel device, wherein the race is formed from a high-temperature plastic and wherein the race includes a gap, such that the race collapses when the swivel device is crimped in the socket.

12. A high-temperature bearing assembly, comprising:
(a) a swivel device disposed in a socket; and
(b) a race disposed between the socket and the swivel device, wherein the race is made from a high-temperature plastic.

13. A method of making a high-temperature bearing assembly, including:
(a) forming a race from a high-temperature plastic, wherein the race is formed in a substantially C-shape;
(b) compressing the race around a swivel device to create a swivel assembly;
(c) inserting the swivel assembly in a socket, such that the race is positioned between the socket and the swivel device; and
(d) crimping the swivel assembly in the socket.

14. The method of claim 13, wherein the race is annealed before being compressed around the swivel device.

15. The method of claim 13, wherein the torque is tested before crimping the swivel assembly in the socket.

16. The method of claim 13, wherein the torque is tested after crimping the swivel assembly in the socket.

17. The method of claim 13, wherein the race has a high-temperature resistance selected from the group consisting of up to at least about 450 degrees F., up to at least about 550 degrees F., up to at least about 650 degrees F., and up to at least about 750 degrees F.

18. The method of claim 13, wherein the material of the race includes a material selected from the group consisting of a polyimide-based polymer, a polyether-ether-ketone thermoplastic, and a polyether-ketone-ether-ketone-ketone thermoplastic.

19. The method of claim 13, wherein the race is formed by compression molding or injection molding.

20. The bearing assembly of claim 13, wherein the race includes a gap.
